(19) United States
(12) Patent Application Publication
(10) Pub. No.: US 2024/0152825 A1
(43) Pub. Date: May 9, 2024

(54) ONE-TOUCH TRAVEL SCHEDULING SYSTEM AND METHOD THEREOF

(71) Applicant: movv corp., Seoul (KR)

(72) Inventor: Min Suk CHOI, Seoul (KR)

(73) Assignee: movv corp., Seoul (KR)

(21) Appl. No.: 18/064,595

(22) Filed: Dec. 12, 2022

(30) Foreign Application Priority Data
Nov. 9, 2022 (KR) 10-2022-0148496

(51) Int. Cl. G06Q 10/02; G06Q 30/0207

(52) U.S. Cl. CPC G06Q 10/025; G06Q 30/0207

(57) ABSTRACT

The present disclosure relates to a travel scheduling system and method thereof, and more particularly, to a travel scheduling system in which a user can easily and quickly establish a travel schedule by displaying a travel schedule list including a plurality of travel schedules on a terminal of a first user, receiving a selection of any one travel schedule by the first user from among a plurality of travel schedules from the terminal of the first user, and generating a travel schedule of the first user by copying the travel schedule selected by the first user, and a method thereof.

### CROSS-REFERENCE TO RELATED APPLICATION

This application claims priority to Korean Patent Application No. 10-2022-0148496 filed on Nov. 9, 2022, and all the benefits accruing therefrom under 35 U.S.C. § 119, the contents of which are incorporated by reference in their entirety.

### BACKGROUND

The present disclosure relates to a travel scheduling system and a method thereof, and more particularly, to a travel scheduling system in which, in generating a travel schedule, a user can easily and quickly establish a travel schedule by copying a travel schedule generated and uploaded by another user in the past and a method thereof.

As the level of income increases, the tourism industry is developing day by day, but the daily life of modern people for the increase in income level is also stained with excessive work and stress. In these exhausting daily lives, many modern people try to relieve stress by experiencing a new environment through travel. As the number of people going on domestic and overseas travel increases, the number of users who choose individual travel to make their own travel out of a routine of package travel has been increasing recently. However, in order to create a schedule for individual travel, information on a destination, a movement means and moving time to move to the destination, operating hours of the destination, etc. is required, it takes a lot of time to search for such information, and it is not easy to plan a travel schedule and budget because, in particular, prices, policies, and cultures are different overseas. Therefore, creating the travel schedule can rather cause stress.

In order to solve this problem, various systems and methods that can create a travel schedule more easily and conveniently are being researched. As an example, there is Korean unexamined patent application publication No. 2016-0064697 entitled “Travel schedule service method and system”. Korean unexamined patent application publication No. 2016-0064697 discloses the matters that a user screen for creating a daily itinerary is displayed within a travel schedule set by a member, and a specific place can be moved from a list the member wants to visit to the daily itinerary by dragging, and thus, a travel plan is established by easily reflecting a desired place to visit and schedule on the daily itinerary compared to a method of inputting corresponding data one by one, thereby providing convenience in creating a travel schedule.

However, even with this prior art, information on each destination, movement means for moving between respective destinations, budget, etc. is still cumbersome because it should be accompanied by a personal search and it is difficult to verify whether a travel schedule prepared by a user is actually feasible or suitable to be carried out until the user travels directly based on the created travel schedule. Accordingly, there is a problem in that the user who prepares the travel schedule has to travel with anxiety about travel.

### SUMMARY

The present disclosure provides a travel scheduling system in which, in generating a travel schedule by a user, the travel schedule of the user is generated by allowing a travel schedule of another user to be copied by simply selecting the travel schedule generated and uploaded by the other user without entering a travel destination, movement means between respective travel destinations, etc. one by one, thereby capable of generating a travel schedule simply and conveniently. The present disclosure is not limited to the travel scheduling system as described above, and another travel scheduling system and a method thereof may be derived from the following description.

In accordance with an exemplary embodiment of the present invention, a travel scheduling method includes displaying a travel schedule list including a plurality of travel schedules on a terminal of a first user, receiving a selection of any one travel schedule by the first user from among a plurality of travel schedules from the terminal of the first user, generating a travel schedule of the first user by copying the travel schedule selected by the first user, and displaying a reservation screen for making a reservation related to the generated travel schedule of the first user on the terminal of the first user, and the plurality of travel schedules are pre-generated by a plurality of users other than the first user.

The travel scheduling method may further include paying a reward to a second user who generated the travel schedule selected by the first user among the plurality of users.

The travel scheduling method may further include calculating a reward to be paid to the second user according to a value of the travel schedule generated by the second user, and, in the paying the reward, the calculated reward may be paid to the second user.

In the calculating the reward, the value of the travel schedule generated by the second user may be determined based on a score evaluated by at least one other user other than the second user for the travel schedule generated by the second user.

Each of the at least one other user evaluated for the travel schedule generated by the second user may be a user who generated a travel schedule by copying the travel schedule generated by the second user and made a reservation related to the generated travel schedule before generating the travel schedule of the first user.

In the calculating the reward, the value of the travel schedule generated by the second user may be determined based on a degree of coincidence between the travel schedule generated by the second user and the travel schedule of the first user.

In the calculating the reward, the degree of between the travel schedule of the first user and the travel schedule of the second user may be calculated, excluding a first departure point of a first day itinerary of the travel schedule of the first user and the travel schedule generated by the second user and a movement means to be boarded at the first departure point.

The travel scheduling method may further include receiving information about a travel budget of the first user from the terminal of the first user, and each travel schedule of the plurality of travel schedules may include information about a budget required for each travel schedule and information about the movement means used to carry out each travel schedule.

The travel scheduling method may further include modifying the travel schedule of the first user by replacing at least one of the movement means used to carry out the travel schedule of the first user when the received travel budget of the first user is less than a budget of the travel schedule selected by the first user. The modifying the travel schedule of the first user may include determining whether there is an alternative movement means for getting on and off at a boarding point and disembarking point of each movement means of the travel schedule of the first user and having a cheaper fare than that of each movement means, and determining at least one movement means for which alternative movement means exists as alternative candidate movement means and replacing at least one of the alternative candidate movement means with the alternative movement means.

The replacing at least one of the at least one alternative movement means with the alternative movement means may include calculating cost savings when each alternate candidate movement means is changed to each alternative movement means, and replacing the alternative candidate movement means having the largest cost savings with the alternative movement means.

The replacing at least one of the at least one candidate movement means with the alternative movement means may include calculating cost savings over time by dividing cost savings when each alternate candidate movement means is changed to each alternative movement means by a moving time increment increased by changing each alternative candidate movement means to each alternative movement means, and replacing the alternative candidate movement means having the largest cost savings over time with the alternative movement means.

Each travel schedule of the plurality of travel schedules may include information about the movement means used to carry out each travel schedule, and the travel scheduling method may further include displaying, on the terminal of the first user, a movement means recommendation screen indicating that a movement means used to carry out the travel schedule of the first user is to be replaced with a recommended movement means.

The recommended movement means may be a vehicle accompanied by a driver.

In accordance with another exemplary embodiment of the present invention, a travel scheduling system includes a list generation unit configured to display a travel schedule list including a plurality of travel schedules on a terminal of a first user, a schedule generation unit configured to receive a selection of any one travel schedule by the first user from among a plurality of travel schedules from the terminal of the first user and generate a travel schedule of the first user by copying the travel schedule selected by the first user, and a reservation unit configured to display a reservation screen for making a reservation related to the generated travel schedule of the first user on the terminal of the first user, and the plurality of travel schedules are pre-generated by a plurality of users other than the first user.

### BRIEF DESCRIPTION OF THE DRAWINGS

Exemplary embodiments can be understood in more detail from the following description taken in conjunction with the accompanying drawings, in which:

FIG. 1 is a configuration diagram for describing a travel scheduling system in accordance with exemplary embodiment of the present invention;

FIG. 2 is a configuration diagram of the travel scheduling system illustrated in FIG. 1;

FIG. 3 is a configuration diagram of a list generation unit illustrated in FIG. 1;

FIG. 4 is a configuration diagram of a schedule adjustment unit illustrated in FIG. 1;

FIG. 5 is a flowchart of a travel scheduling method in accordance with an exemplary embodiment of the present invention;

FIG. 6 is a diagram illustrating a screen displayed to receive user information from a user in accordance with another exemplary embodiment;

FIG. 7 is a diagram illustrating a schedule list displayed in accordance with another exemplary embodiment;

FIG. 8 is a diagram illustrating a screen displayed to the user when one of the travel schedules in the schedule list illustrated in FIG. 7 is pressed;

FIG. 9 is a diagram illustrating a screen for making a reservation related to the travel schedule illustrated in FIG. 8; and

FIG. 10 is a diagram for helping understanding of the schedule adjustment unit in accordance with still another exemplary embodiment.

### DETAILED DESCRIPTION OF EMBODIMENTS

Hereinafter, embodiments of the present disclosure will be described in detail with reference to the drawings. Embodiments of the present disclosure described below relate to a travel scheduling system in which a user can generate a travel schedule of the user by copying a travel schedule uploaded by another user with a single touch and a method thereof, and a travel scheduling system for generating a travel schedule may be briefly referred to as a “scheduling system” and a travel scheduling method for generating the travel schedule may be referred to as a “scheduling method”.

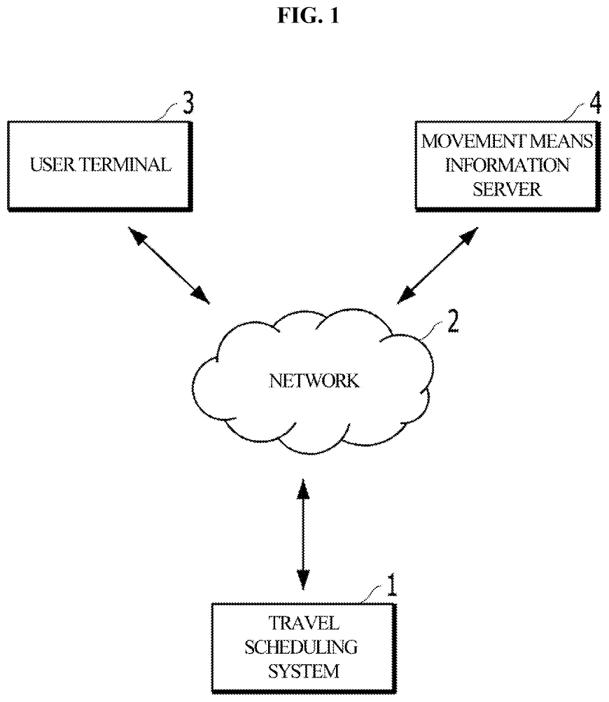

FIG. 1 is a configuration diagram for describing a travel scheduling system 1 in accordance with exemplary embodiment of the present invention. Referring to FIG. 1, the scheduling system 1 according to this embodiment wirelessly communicates with a user terminal 3 and movement means information server 4 through a network 2, and provides various web pages to the user terminal 3 so that the user can easily create a travel schedule. The scheduling system 1 generates a travel schedule for the user based on information received from at least one of the user terminal 3 and the movement means information server 4. In this embodiment, the scheduling system 1 may be a computer device or a server, which is implemented by a plurality of computer devices, that communicates with the user terminal 3 and the movement means information server 4 through the network 2 to provide a command, code, file, content, service, etc.

The network 2 is an interlocking network that supports the scheduling system 1 to communicate with the user terminal 3 and the movement means information server 4, and may include various communication networks such as a wireless LAN network, a mobile communication network, an Internet network, and a portable Internet network.

The user terminal 3 accesses and logs in the scheduling system 1 through the network 2 according to input of the user, and displays various web pages for using a scheduling service provided from the scheduling system 1. The user terminal 3 may be a mobile phone terminal capable of accessing the Internet, or may be a computer device such as a laptop computer or a desktop computer. The user terminal 3 may be loaded with a predetermined application program corresponding to the scheduling system of this embodiment. Hereinafter, for a more concise description, a user terminal of a first user may be referred to as a terminal of the first user.

The movement means information server 4 is a computer device or a server, which is implemented by a plurality of computer devices, that communicates with the scheduling system 1 through the network 2 to provide a command, code, file, content, service, etc., and provides the scheduling system 1 with information on various movement means that the user can use during travel, and makes a reservation for each movement means. The scheduling system 1 receives data from the movement means information server 4 to provide information on movement means suitable for the travel schedule of the user, and reserves each movement means selected by the user through the movement means information server 4.

In one embodiment of the present disclosure, the movement means information server 4 may be composed of a plurality of servers each of which is managed by each operating entity of a plurality of movement means that the user may use during travel. For example, the movement means information server 4 may be composed of server a managed by railroad company A, server b managed by railroad company B, server c managed by airline C, and server d managed by rental car company D. Each server provides information such as operation time, operation route, and fare cost for the movement means supplied by each operating entity. When the scheduling system 1 requires information on train A′ operated by railroad company A to create a travel schedule of a user, the information on train A′ can be obtained through the server a, and the reservation for train A′ can also be performed through the server a.

In another embodiment of the present disclosure, the movement means information server 4 may be one integrated server that receives and stores data related to each movement means from a plurality of servers managed by a plurality of operating entities, and makes reservations for each movement means.

In the following description, ‘travel destination’ refers to a place that a user wants to experience or visit, and may refer to countries such as Korea and Japan, cities such as Seoul and Tokyo, or specific tourists spot such as Deoksugung Palace, Namsan N Tower, and Starbucks Seolleung Station. Further, unless otherwise specified, in the following description, ‘user’ refers to any one user who uses the scheduling system of this embodiment. In addition to this, the first user may be used to refer to any one user who wants to plan travel using the scheduling system 1 of this embodiment, and the second user may be used to refer to another user who uses the scheduling system 1 of this embodiment and is different from the first user.

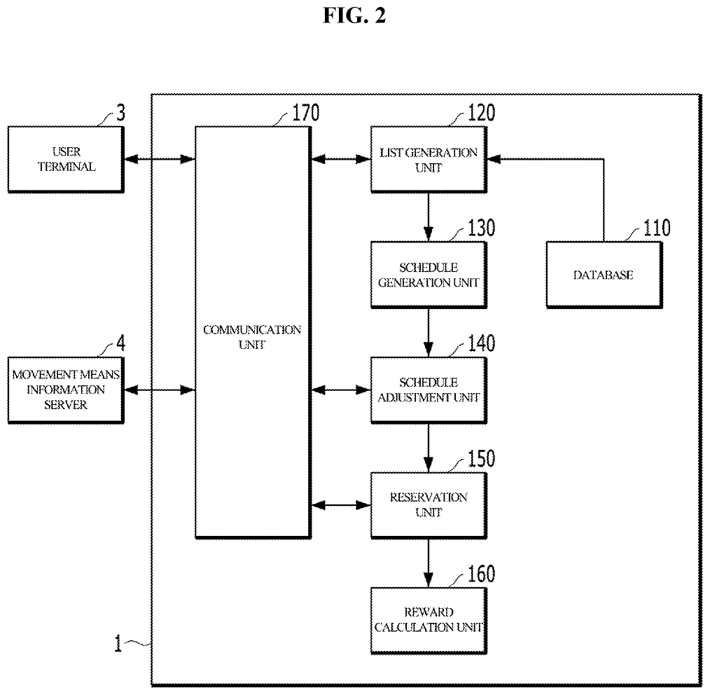

Hereinafter, the scheduling system 1 according to this embodiment will be described in detail with reference to FIGS. 2 to 10.

FIG. 2 is a configuration diagram of the scheduling system 1 according to this embodiment. Referring to FIG. 2, the scheduling system 1 according to this embodiment is composed of a database 110, a list generation unit 120, a schedule generation unit 130, a schedule adjustment unit 140, a reservation unit 150, and a reward calculation unit 160, and a communication unit 170. Those skilled in the art to which this embodiment pertains can understand that the list generation unit 120, the schedule generation unit 130, the schedule adjustment unit 140, the reservation unit 150, and the reward calculation unit 160 may be implemented as hardware providing specific functions or may be implemented as a combination of a memory, in which software providing specific functions is recorded, a processor, a bus, etc. Each of the components described above is not necessarily implemented as separate hardware, and several components may be implemented by a combination of common hardware, for example, a processor, memory, bus, etc.

The database 110 stores personal information of users using the scheduling system 1, information related to travel destinations, and a plurality of travel schedules generated and uploaded by a plurality of users using the scheduling system 1.

The personal information of users includes activity information of the users in the scheduling system 1 such as a list of travel destinations registered by each user as a travel destination of interest, a travel schedule generated by each user using the scheduling system (1), a list of travel destinations searched by each user within the scheduling system (1), etc. as well as personal information such as name, gender, contact information, date of birth, etc. entered by each user using the scheduling system (1) when registering as a member to use the scheduling system (1) in the past.

The travel destination-related information is information about each travel destination, and includes information that the user can refer to when traveling to the corresponding travel destination, such as the locations of respective travel destinations, photos, operational information, usage fees, comments left by travelers on the corresponding travel destination, tags (e.g., food tour, shopping, activities, natural recreation, etc.) set by travelers, the number of recommendations made by users for the corresponding travel destination, etc.

Each travel schedule is an itinerary in which travel destinations visited by the user are listed in chronological order during the travel period, and includes at least one of travel period, one or more travel destinations visited during the travel period, usage fee of each travel destination, departure time and arrival time of each travel destination, length of stay at each travel destination, movement means between respective travel destinations and their fare costs, and total cost required to carry out each travel schedule, cost of movement, and tag (e.g., healing trip, shopping, food tour, etc.) information for each travel schedule. Here, the total cost refers to the sum of all costs required to carry out the corresponding travel schedule, such as entrance fees to travel destinations included in each travel schedule and cost of movement between travel destinations. The cost of movement refers to the sum of the fare costs of the movement means required for moving between travel destinations.

The tag for each travel schedule may be set by the user who generated each travel schedule, may be arbitrarily set by the scheduling system 1 by classifying tags added to a plurality of travel destinations included in each travel schedule, or may not be set according to circumstances.

Meanwhile, in the database 110, ratings added by users of the scheduling system 1 to the corresponding travel schedule in response to each travel schedule are stored. In this case, the ratings for each travel schedule are added by the users who generated a travel schedule by copying a travel schedule using the scheduling system (1), made a travel-related reservation, and then carried out travel.

That is, the rating for each travel schedule is a score evaluated by another user based on his/her travel experience using a travel schedule after one user generates the corresponding travel schedule using the scheduling system 1. Therefore, the rating added to each travel schedule is one obtained by reflecting opinions of people who have actually traveled based on each travel schedule and is set by reflecting the feasibility of an itinerary of each travel schedule, the convenience and comfort of the itinerary, etc. Therefore, if a user who generates a travel schedule generates a travel schedule by copying a travel schedule having a high rating among travel schedules generated by other users in the past, the user is able to more reliably plan travel with high satisfaction.

In one embodiment of the present disclosure, each travel schedule stored in the database 110 may be one uploaded by a user who has actually traveled based on each travel schedule generated, after generating each travel schedule through the scheduling system 1.

The communication unit 170 is connected to the user terminal 3 and the mobile means server 4 through wireless communication, transmits a signal to the user terminal 3 and the movement means information server 4 in conjunction with a control signal input from the list generation unit 120, the schedule adjustment unit 140, and the reservation unit 150, and receives a signal from the user terminal 3 and the movement means information server 4. Hereinafter, those skilled in the art will easily understand that signal transmission and reception between the list generation unit 120, the schedule adjustment unit 140, the reservation unit 150, the user terminal 3, and the movement means information server 4 is performed through the communication unit 170 even without a separate explanation.

The list generation unit 120 generates and provides a list of travel schedules including at least one travel schedule among a plurality of travel schedules stored in the database 110 to the terminal 3 of the first user who wants to generate a travel schedule using the scheduling system 1 according to this embodiment. The list generation unit 120 may generate the travel schedule list to be provided to the first user based on at least one of information directly input by the first user and preference of the first user automatically calculated by the scheduling system 1.

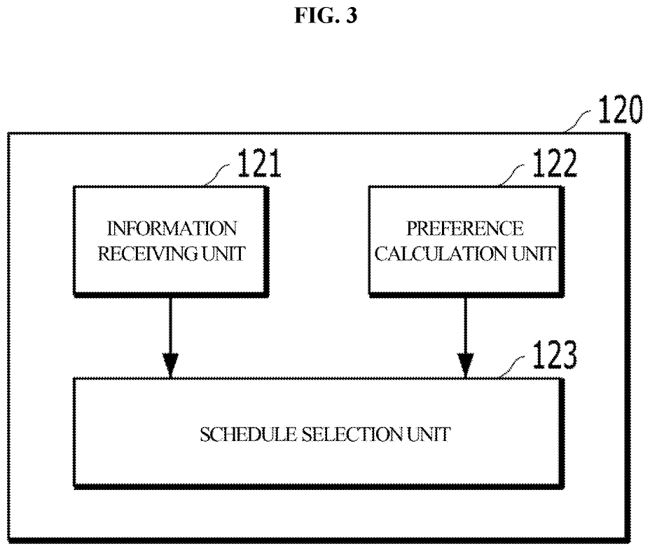

FIG. 3 is a configuration diagram of the list generation unit 120 of the scheduling system 1 according to this embodiment. Referring to FIG. 3, the list generation unit 120 according to this embodiment is composed of an information receiving unit 121, a preference calculation unit 122, and a schedule selection unit 123.

The information receiving unit 121 transmits a travel-related information input screen for receiving travel-related information from the first user to the terminal 3 of the first user, and receives travel-related information of the first user input in response thereto from the terminal 3 of the first user.

For example, the information receiving unit 121 provides the travel-related information input screen including an input field for receiving a desired travel destination, travel period, travel budget, transportation cost budget, number of accompanying persons, and a concept tag representing desired travel concept of the the first user to the terminal 3 of the first user, and receives the travel-related information of the first user input through the input field of the input screen.

Meanwhile, if none of the desired travel destination, travel period, travel budget, transportation cost budget, number of accompanying persons, or the concept of the desired travel has not been determined in relation to the travel is determined, the first user may receive a list of travel schedules arbitrarily provided by the schedule selection unit 123 by submitting the input field on the travel-related information input screen for receiving travel-related information provided by the information receiving unit 121 as blank.

The preference calculation unit 122 calculates preference of the first user based on the personal information of the first user stored in the database 110, thereby enabling selection of a travel schedule considering the preference of the first user among a plurality of travel schedules stored in the database 110.

The preference calculation unit 122 automatically calculates the preference of the first user based on at least one of personal information and activity information of the first user stored in the database 110.

The preference calculation unit 122 may calculate preference of a user based on the personal information of the first user stored in the database 110. In this embodiment, the preference calculation unit 122 may calculate the preference of the user based on the personal information of the first user and personal information and activity information of other users stored in the database 110.

First, the preference calculation unit 122 obtains gender and age information of the first user from the personal information of the first user stored in the database 110, and determines users having an age belonging to a certain range, which includes the same gender as the first user and the age of the first user, among other users using the scheduling system 1 as a preference similar group, based on the obtained gender and age of the first user. In this time, an age range for determining the preference similar group may be set in consideration of the distribution of customer groups using the scheduling system 1 or the characteristics of each age group, and may be set to ±3 years in this embodiment.

For example, if it is determined that the first user is a woman and is 25 years old based on the personal information of the first user stored in the database 110, the preference calculation unit 122 sets female users of 22 years of age or more and 28 years of age or less from the database as the preference similar group.

Thereafter, the preference calculation unit 122 calculates the preference of the first user based on activity information of other users constituting the similar preference group. In this embodiment, the preference calculation unit 122 may determine a tendency of which travel destinations other users of the preference similar group prefer by extracting tags set for the travel destinations stored as travel destinations of interest by other users constituting the preference similar group. For example, as a result of extracting the tags of travel destinations saved by other users of preference similar group as travel destinations of interest, if it is determined that ‘shopping’ is approximately 36 cases, ‘restaurant tour’ is approximately 45 cases, ‘natural recreation’ is approximately 12 cases, and ‘activity’ is approximately 21 cases, the preference calculation unit 122 may infer that the first user would prefer a travel destination in the order of restaurant tour, shopping, activity, and natural recreation, based on the personal information of the first user.

Meanwhile, the preference calculation unit 122 may calculate the preference of the first user based on the activity information of the first user stored in the database 110. The preference calculation unit 122 may calculate the preference of the first user based on the travel destination saved by the first user as a travel destination of interest, a travel destination searched within the scheduling system 1 by the first user, and a travel schedule generated by the first user in the past using the scheduling system 1. For example, the preference calculation unit 122 may calculate the preference of the first user by extracting a tag of each of the travel destinations saved by the first user as the travel destination of interest, the travel destination searched within the scheduling system 1, and the travel schedule generated in the past using the scheduling system 1. As a result of extracting the tag of each of the travel destination saved by the first user as the travel destination of interest, the travel destination searched within the scheduling system (1), and the travel schedule generated using the scheduling system 1 and adding all of them, if it is determined that ‘shopping’ is approximately 16 cases, ‘restaurant tour’ is approximately 14 cases, ‘natural recreation’ is approximately 8 cases, and ‘activity’ is approximately 2 cases, the preference calculation unit 122 may infer that the first user would prefer the travel destination in the order of shopping, restaurant tour, activity, and natural recreation, based on the activity information of the first user.

The schedule selection unit 123 extracts one or more travel schedules from among a plurality of travel schedules stored in the database 110 based on at least one of the travel-related information of the first user received by the information receiving unit 121 and the preference of the first user calculated by the preference calculation unit 122 to generate a list of travel schedules, and provides the generated travel schedule list to the terminal 3 of the first user. In this embodiment, when extracting one or more travel schedules from among the plurality of travel schedules, the schedule selection unit 123 may extract travel schedules generated and uploaded by other users different from the first user, thereby providing a more useful list of travel schedules to the first user.

In one embodiment of the present disclosure, the schedule selection unit 123 may select the travel schedule based on the desired travel destination of the first user from among the travel-related information of the first user received by the information receiving unit 121. More specifically, the schedule selection unit 123 may generate the list of travel schedules by selecting one or more travel schedules related to the desired travel destination of the first user received from the terminal 3 of the first user from among the plurality of travel schedules stored in the database 110.

For example, if the desired travel destination of the first user received by the information receiving unit 121 is ‘Busan’, the schedule selection unit 123 generates a travel schedule list in which one or more travel schedules related to ‘Busan’ are collected from among the plurality of travel schedules stored in the database 110.

Meanwhile, in this embodiment, the schedule selection unit 123 may generate or sort the travel schedule list by reflecting the preference of the first user calculated by the preference calculation unit 122. After selecting one or more travel schedules related to the desired destination of the first user received by the information receiving unit 121 from among the plurality of stored travel schedules, the schedule selection unit 123 may sort the list based on the preference of the first user calculated by the preference calculation unit 122.

For example, if the plurality of travel schedules related to ‘Busan’ were selected based on the travel-related information of the first user received by the information receiving unit 121 and the preferences of the first user calculated by the preference calculation unit 122 are in the order of shopping, restaurant tour, activity, and natural recreation, the schedule selection unit 123 may expose the travel schedule that meets the preference of the first user at the top and transmit the travel schedule to the terminal 3 of the first user by arranging, among selected plurality of travel schedules, a travel schedule for which a shopping tag is set at the top and a travel schedule for which a restaurant tour tag is set at the bottom.

In another embodiment of the present disclosure, when it is determined that the travel-related information of the first user has not been received by the information receiving unit 121 from the terminal 3 of the first user, the schedule selection unit 123 may generate and provide a list of travel schedules based only on the preferences of the first user calculated by the preference calculation unit 122. For example, the schedule selection unit 123 may select one or more travel schedules matching the preferences of the first user calculated by the preference calculation unit 122 among the plurality of travel schedules stored in the database 110 to generate a list of travel schedules and provide the list to the terminal of the first user.

In still another embodiment of the present disclosure, when it is determined that the travel-related information of the first user has not been received by the information receiving unit 121 from the terminal 3 of the first user, the schedule selection unit 123 may transmit a list of travel schedules including travel schedules having higher ratings among the plurality of travel schedules stored in the database 110 to the terminal 3 of the first user.

Meanwhile, the list generation unit 120 lists a plurality of travel schedules by displaying only information for distinguishing each travel schedule on the first screen when generating the list of travel schedules and generates the list of travel schedules so that the detailed details of each travel schedule can be viewed when the first user requests detailed information on each travel schedule, thereby enables the first user to more conveniently view the list of travel schedules. Meanwhile, a request for detailed information on each travel schedule from the first user may be recognized when the first user touches an area where each travel schedule is displayed on a screen of the terminal of the first user.

In one embodiment of the present disclosure, information for distinguishing each travel schedule may be a title of each travel schedule, a concept tag, and a photo of a travel destination included in each travel schedule.

The schedule generation unit 130 generates a schedule of the first user based on the selection of the desired travel schedule of the first user received in response to the list generation unit 120 providing the list of travel schedules to the terminal 3 of the first user.

The schedule generation unit 130 receives, from the terminal 3 of the first user, a selection for any one desired travel schedule that the first user desires to travel from among one or more travel schedules included in the travel schedule list in response to the list generation unit 120 providing the list of travel schedules to the terminal 3 of the first user. The schedule generation unit 130, which receives the selection by the first user from the terminal 3 of the first user, generates the travel schedule of the first user by copying the desired travel schedule selected by the first user, and provides the generated travel schedule to the terminal 3 of the first user.

In one embodiment of the present disclosure, the schedule generation unit 130 may copy travel period, one or more travel destinations to be visited during the travel period, usage fee of each travel destination, departure time and arrival time of each travel destination, length of stay at each travel destination, movement means between respective travel destinations and their fare costs, and tag information for each travel schedule and insert these information into the itinerary of the first user to generate the same copied travel schedule of the first user as the desired travel schedule selected by the first user.

Meanwhile, the schedule generation unit 130 may display, on the terminal 3 of the first user, a movement means recommendation screen indicating that the movement means for moving between respective travel destinations of the travel schedule of the first user is to be replaced with a recommended movement means. In this case, the schedule generation unit 130 also displays fare cost information of the recommended movement means and a selection button, through which the first user can select whether or not to use the recommended movement means, on the movement means recommendation screen.

In one embodiment, the recommended movement means displayed by the schedule generation unit 130 is a vehicle accompanied by a driver, and the vehicle used for this may be a commercial vehicle such as a rental car or a private vehicle owned by the driver. In addition, the fare cost thereof may be calculated by at least one of the moving distance, the size of the provided vehicle, and the moving time.

The schedule generation unit 130 calculates the moving distance between respective travel destinations in the travel schedule of the first user based on location information of each travel destination stored in the database 110, and calculates the fare cost based on the calculated total sum of moving distances between respective travel destinations. For example, the fare cost for the recommended movement means can be calculated as approximately 50,000 won if the total sum of the moving distances between respective travel destinations is less than approximately 100 km, approximately 80,000 won if the total sum of the moving distances between respective travel destinations is approximately 100 km and less than approximately 150 km, and approximately 150,000 won if the total sum of the moving distances between respective travel destinations is approximately 150 km or more. The schedule generation unit 130 may set the calculated cost as the cost of movement of the travel schedule of the first user and display the set cost of movement on the movement means recommendation screen. When the selection by the first user indicating the use of the recommended movement means from the terminal 3 of the first user, the schedule generation unit 130 generates a travel schedule in which the movement means between respective travel destinations is changed to the recommended movement means, and provides the travel schedule to the terminal 3 of the first user as the travel schedule of the first user.

In this way, as the schedule generation unit 130 recommends the vehicle accompanied by the driver as a recommended movement means, the first user may travel to the same travel destination as in the travel schedule of the second user, but may travel more privately and comfortably using the vehicle accompanied by the driver rather than public transportation.

In another embodiment, the recommended movement means displayed by the schedule generation unit 130 may be a movement means different from the movement means for moving between respective travel destinations of the desired travel schedule selected by the first user. Here, the difference in movement means may mean that a type of movement means are different, or the type of movement means may be the same but a moving route may be different. For example, the schedule generation unit 130 may display bus No. YYY having the same type but having the different moving route as a recommended movement means that replaces bus No. XXX used to move one moving section of the desired travel schedule, and may display other types of subways as the recommended movement means.

On the other hand, when the movement means recommendation screen is displayed on the terminal 3 of the first user by the schedule generation unit 130 and the first user selects to travel to each travel destination in the travel schedule of the first user using the recommended movement means, adjustment of the travel schedule by the schedule adjustment unit 140 described below may be omitted. This is to omit unnecessary work because the recommended movement means is the vehicle accompanied by the driver and thus there is no room for problems such as changing operating hours, and, when the first user chooses to use the recommended movement means, it can be regarded that he/she has already confirmed the fare cost and is willing to pay it.

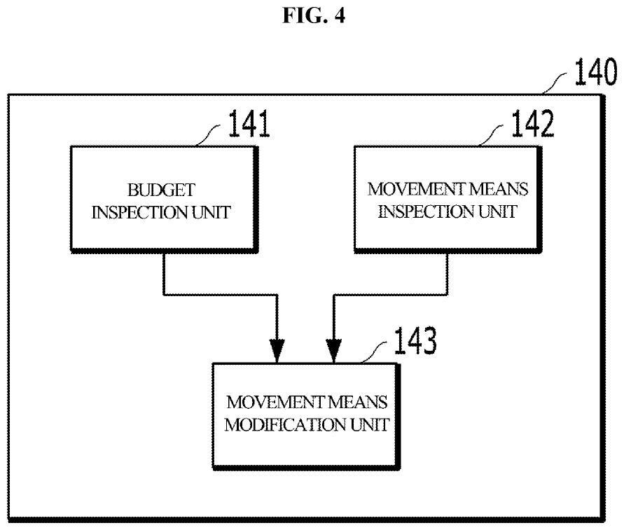

The schedule adjustment unit 140 inspects the travel schedule of the first user generated by the schedule generation unit 130, adjusts the travel schedule of the first user according to the inspection result, and transmits the adjusted schedule to the terminal 3 of the first user as the travel schedule of the first user. FIG. 4 is a diagram illustrating the configuration of the schedule adjustment unit 140 according to this embodiment. Referring to FIG. 4, the schedule adjustment unit 140 includes a budget inspection unit 141, a movement means inspection unit 142, and a movement means modification unit 143.

The budget inspection unit 141 determines budget appropriateness of the travel schedule of the first user generated by the schedule generation unit 130 by comparing the cost required for the travel schedule of the first user generated by the schedule generation unit 130 and the budget of the first user received by the information receiving unit 121.

In one embodiment of the present disclosure, the budget inspection unit 141 may determine the budget appropriateness of the travel schedule of the first user by comparing the total cost for the desired travel schedule of the first user generated by the schedule generation unit 130, that is, the desired travel schedule selected by the first user, with the travel budget of the first user received by the information receiving unit 121. The budget inspection unit 141 may determine that the travel schedule of the first user generated by the schedule generation unit 130 lacks budget appropriateness when the total cost for the travel schedule of the first user generated by the schedule generation unit 130 is greater than the travel budget of the first user received by the information receiving unit 121.

In another embodiment of the present disclosure, the budget inspection unit 141 may determine the budget appropriateness of the travel schedule of the first user by comparing the cost of movement required for the travel schedule of the first user generated by the schedule generation unit 130 with a transportation cost budget of the first user received by the information receiving unit 121. The budget inspection unit 141 may determine that the travel schedule of the first user generated by the schedule generation unit 130 lacks budget adequacy when the cost of movement for the travel schedule of the first user generated by the schedule generation unit 130 is greater than the transportation cost budget of the first user received by the information receiving unit 121.

The movement means inspection unit 142 determines whether or not the movement means for moving to each travel destination of the travel schedule of the first user generated by the schedule generation unit 130 is valid even at the time when the first user plans scheduling.

The movement means inspection unit 142 determines, based on information of respective movement means stored in the movement means information server 4, whether or not each movement means included in the travel schedule of the first user is still valid at the time when the first user plans scheduling.

In this embodiment, the movement means inspection unit 142 receives information about whether or not the corresponding line of each movement means included in the schedule of the first user operates at the current time, whether or not the operation time thereof is changed, and whether or not the fare cost thereof is changed, from the movement means information server 4, and determines, based on the received information, that the movement means is invalid when the line operation of one or more movement means has ended or the operation time or fare thereof has been changed. For example, the movement means inspection unit 142 determines that the movement using bus No. M is invalid when the bus No. M among the movement means constituting the schedule of the first user is not in operation because the line is currently closed.

The movement means modification unit 143 modifies the movement means of the travel schedule of the first user based on the determinations of the budget inspection unit 141 and the movement means inspection unit 142. In this embodiment, when the budget inspection unit 141 determines that the travel schedule of the first user lacks budget appropriateness, or when the movement means inspection unit 142 determines that at least one of the movement means of the travel schedule of the first user is not valid, the movement means modification unit 143 may modify the movement means of the travel schedule of the first user.

When it is determined, by the budget inspection unit 141, that the travel schedule of the first user lacks budget appropriateness, the movement means modification unit 143 replaces at least one movement means among a plurality of movement means constituting the travel schedule of the first user with a movement means having a lower cost of movement to reduce the overall budget of the travel schedule of the first user.

In this embodiment, the movement means modification unit 143 checks, through the movement means information server 4, whether an alternative movement means, which can be moved along the same route as that of each movement means constituting the travel schedule of the first user and has a lower cost of movement, exists. More specifically, the movement means modification unit 143 checks, through the movement means information server 4, whether or not an alternative movement means including the same boarding place and disembarking place as those of each movement means constituting the travel schedule of the first user exists. As a result of the check, one or more movement means for which the alternative movement means exists among a plurality of movement means constituting the travel schedule of the first user is determined as an alternate candidate movement means.

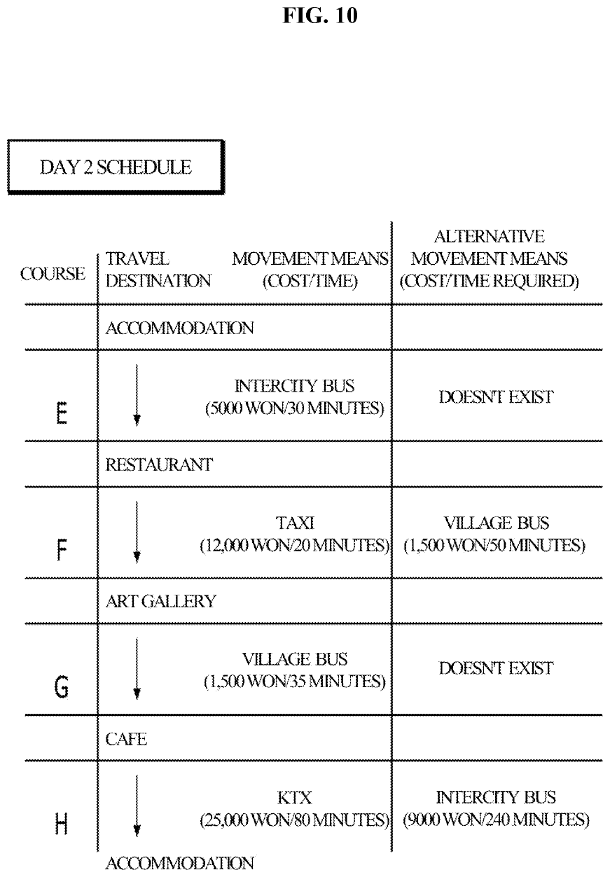

FIG. 10 is a diagram for helping understanding of the schedule adjustment unit in accordance with still another exemplary embodiment, illustrates a plurality of travel destinations, the movement means for moving between respective travel destinations, and the cost of movement and moving time of each movement means that constitutes the second day schedule of the travel schedule of the first user, and illustrates each alternative movement means and the cost of movement and moving time of each alternative movement means when alternative movement means of each movement means exists.

Referring to FIG. 10, first of all, in the case of E course from the accommodation to the restaurant, and G course from the museum to the cafe, there is no alternative movement means that can replace an intercity bus and village bus each of which is the movement means. In contrast, on the F course from the restaurant to the museum, there is a village bus that can replace the taxi, and on the H course from the cafe to the accommodation, there is an intercity bus that can replace the KTX. Accordingly, the movement means modification unit 143 determines the taxi of the F course and the KTX of the H course as alternative candidate movement means.

Thereafter, the movement means modification unit 143 replaces one or more alternative candidate movement means in the travel schedule of the first user with an alternative movement means based on the cost effect that can be obtained when replacing each alternative candidate movement means with alternative movement means.

In one embodiment of the present disclosure, the movement means modification unit 143 may replace the alternative candidate movement means, for which the cost difference between each alternative candidate movement means and the alternative movement means corresponding to each alternative candidate movement means, that is, the cost saved when each alternative candidate movement means is replaced with each alternative movement means is the largest, with the alternative movement means.

Referring to FIG. 10, the movement means modification unit 143 calculates the cost savings in the case of replacing the taxi of the F course with the village bus and the case of replacing the KTX of the H course with the intercity bus. As a result of the calculation, in the case of replacing the taxi of course F is replaced with the village bus, the cost is reduced by approximately 10,500 won (12000-1500 won), and, in the case of replacing the KTX of Course H with a wide area bus, the cost is reduced by approximately 16,000 won (25,000-9,000 won), and thus the movement means modification unit 143 may determine to replace the KTX of the H course with the intercity bus, and transmit a travel schedule in which the KTX of the H course is replaced with the intercity bus as the travel schedule of the first user to the terminal 3 of the first user.

In another embodiment of the present disclosure, the movement means modification unit 143 may replace the alternative candidate movement means, which has the largest cost reduction over time when replaced by the alternative movement means, with the alternative movement means.

Referring to FIG. 10, the movement means modification unit 143 calculates and compares cost savings over time in the case of replacing the taxi of the F course with the village bus and the case of replacing the KTX of the H course with the intercity bus.

In the case of replacing the taxi of the F course with the village bus, the moving time increased by approximately 30 minutes, but the cost was reduced by approximately 10,500 won, and thus the movement means modification unit 143 may determine that a cost of approximately 3,500 won per 10 minutes is reduced when the taxi of course F is replaced with the village bus. On the other hand, in the case of replacing the KTX of the H course with the intercity bus, the moving time increased by approximately 160 minutes, but the cost decreased by approximately 16,000 won, and thus the movement means modification unit 143 may determine that a cost of approximately 1,000 won per 10 minutes is reduced when the KTX of the H course is replaced with the wide area bus. Accordingly, in this embodiment the movement means modification unit 143 may determine to replace the taxi of the F course, which has a large cost savings over time, with the village bus, and transmit a travel schedule in which the taxi of course F is replaced with the village bus to the terminal 3 of the first user as the travel schedule of the first user.

On the other hand, when it is determined that the movement means for moving to each travel destination in the travel schedule of the first user is not valid at the time when the first user plans the scheduling, the movement means modification unit 143 provides a travel schedule in which the movement means that is not valid is replaced with another valid movement means to the first user.

In this embodiment, the movement means modification unit 143 checks, through the movement means information server 4, whether or not there is an alternative movement means that can be used in place of the movement means, which is not valid at the time when the first user plans the scheduling, among the movement means constituting the travel schedule of the first user.

More specifically, the movement means modification unit 143 checks, through the movement means information server 4, whether or not there is an alternative movement means for getting on and off at the boarding point and disembarking point of each invalid movement means constituting the travel schedule of the first user.

As a result of the check, when there is an alternative movement means that can replace the invalid movement means among the plurality of movement means constituting the travel schedule of the first user, a travel schedule in which each invalid movement means is replaced with an alternative movement means is generated and provided to the terminal 3 of the first user as the travel schedule of the first user.

On the other hand, as a result of the check, when there is no alternative movement means that can replace the invalid movement means among the plurality of movement means constituting the travel schedule of the first user, the movement means modification unit 143 transmits a notification indicating that the travel destination is to be changed to the terminal 3 of the first user because the corresponding movement means is unavailable.

In this way, the movement means inspection unit 142 can determine the validity of the movement means included in the travel schedule of the first user and modify the movement means based on the determination to prevent the occurrence of unexpected inconvenience to the first user during travel due to a difference between the time when the travel schedule selected by the first user from the travel schedule list is generated by another user and the time when the first user selects and copies the corresponding travel schedule.

The reservation unit 150 transmits a reservation screen for making a reservation related to the travel schedule of the first user to the terminal 3 of the first user, and receives reservation information necessary for reservation from the terminal 3 of the first user and makes the reservation related to the travel schedule.

In this embodiment, the reservation unit 150 transmits the reservation screen for making a reservation for boarding of the movement means within the travel schedule of the first user to the terminal 3 of the first user. The reservation screen provided by the reservation unit 150 to the terminal 3 of the first user includes an input field for receiving reservation information of the first user necessary to reserve each means of use, such as a name of a person making the reservation, contact information, passport number, and payment information.

The reservation unit 150 receives reservation information of the first user input through the reservation screen from the terminal 3 of the first user, and makes reservations for a plurality of movement means included in the travel schedule of the first user using the received reservation information.

In one embodiment of the present disclosure, the reservation unit 150 may mediate so that the operating entity of each movement means can make a reservation for the first user, by receiving reservation information of the first user input through the reservation screen from the terminal 3 of the first user and transmitting the reservation information to the movement means information server 4.

The reward calculation unit 160 provides a reward to the second user who generated a desired travel schedule selected by the first user from the list of travel schedules provided by the list generation unit 120.

In this embodiment, when the first user selected a travel schedule generated and uploaded by the second user in the past through the scheduling system 1 as a desired travel schedule, the travel schedule of the first user was generated by copying the travel schedule generated by the second user by the schedule generation unit 130 by the selection by the first user, and it is determined that the reservation unit 150 has made a reservation related to the travel schedule of the first user, the reward calculation department 160 provides a reward to the second user.

In this embodiment, the reward provided to the second user by the reward calculation unit 160 may be a point or voucher that can be used within the scheduling system 1, but is not limited thereto, and can be easily adopted by those skilled in the art if it can benefit the second user.

In one embodiment of the present disclosure, the reward calculation unit 160 determines an amount of the reward to be provided to the second user based on the value of the travel schedule of the second user copied by the first user.

The reward calculation unit 160 may calculate the value of the second user travel schedule based on the ratings stored in the database 110 corresponding to the travel schedule of the second user, and determine the amount of the reward to be provided to the second user according to the calculated value.

For example, the reward calculation unit 160 may provide a reward of approximately 1000 points to the second user when the rating of the travel schedule of the second user copied by the first user is 2 points out of 5 points, and provide a reward of approximately 2000 points to the second user when the rating of the travel schedule of the second user is 4 points. That is, the second user can obtain a higher reward as the travel schedule generated in the past receives a higher rating from other users.

In this way, as the reward calculation unit 160 does not collectively provide the same points as a reward to the second user who provided the travel schedule copied by the first user, but pays points differently according to the value of the travel schedule provided, users of the scheduling system 1 are motivated to plan quality travel schedules that can receive higher ratings from other users, and thus it is advantageous for the scheduling system 1 to secure quality travel schedules.

In another embodiment of the present disclosure, the reward calculation unit 160 determines the amount of the reward to be provided to the second user based on the degree of coincidence between the travel schedule of the second user and the travel schedule of the first user generated by copying the travel schedule of the second user.

The reward calculation unit 160 calculates the degree of coincidence between the travel schedule of the second user and the travel schedule of the first user by comparing a plurality of travel destinations and movement means for moving between respective travel destinations constituting the travel schedule of the second user and the plurality of travel destinations and movement means for moving between respective travel destinations constituting the travel schedule of the first user, and determines the amount of the reward to be provided to the second user based on the calculated degree of coincidence.

For example, if the schedule of the second user copied by the first user is not modified at all by the schedule coordinator 140 and becomes the travel schedule of the first user as copied by the schedule generation unit 130, the travel schedule of the first user is exactly the same as the travel schedule of the second user, and thus the reward calculation unit 160 may calculate the degree of coincidence between the two travel schedules as 100% and provide a reward of approximately 2000 points to the second user. If the degree of coincidence between the travel schedule of the second user and the travel schedule of the first user is calculated as 50%, the reward calculation unit 160 may provide a reward of approximately 1000 points to the second user. That is, as the travel schedule of the first user and the travel schedule of the second user coincide with each other, the second user may obtain a higher reward.

In this embodiment, when calculating the degree of coincidence between the travel schedule of the second user and the travel schedule of the first user, the reward calculation unit 160 may calculate the degree of coincidence by setting different weights for different travel destinations and different movement means.

In one embodiment of the present disclosure, as a result of determining the different pieces of information between the travel schedule of the first user and the travel schedule of the second user, the reward calculation unit 160 may reduce the degree of coincidence between two travel schedules more when the travel destinations are different from each other than when the movement means are different from each other. For example, as a result of comparing the travel schedule of the first user and the travel schedule of the second user, the reward calculation unit 160 may determine that the degree of coincidence between the two travel schedules is lower when one travel destination and one movement means information differ from each other than when information on the two movement means differs from each other.

In this embodiment, in calculating the degree of coincidence between the travel schedule of the first user and the travel schedule of the second user, the reward calculation unit 160 may exclude a first departure point and the movement means used at the first departure point of a first day itinerary of each of the travel schedules of the first user and second user from calculating the degree of coincidence.

In other words, in generating the travel schedule by copying the travel schedule of the second user by the first user, in the case where only the first departure point of the first day itinerary and the movement means used at the first departure point are allocated differently, the travel schedule of the first user and the travel schedule of the second user are calculated to have 100% coincidence. This is to prevent the second user from receiving an unfairly small reward because the departure point may be different due to the difference in residence of the first user and the second user and a difference in movement means may inevitably occur due to the difference in residence.

In this way, the scheduling system 1 of this embodiment provides a reward for provision of the travel schedule copied by the first user to the second user through the reward calculation unit 160, thereby capable of motivating the users using the scheduling system 1 to generate and upload higher quality travel schedules. After all, this is advantageous because it can form a virtuous cycle structure in which a travel schedule is generated and uploaded through the scheduling system 1 and the travel schedule stored in the scheduling system 1 is used to generate the travel schedule of the person himself/herself.

According to the scheduling system 1 according to the embodiment of the present disclosure, in generating a travel schedule by the first user, the first user simply selects one of the travel schedules previously generated by other users and stored in the database 110 to copy the selected travel schedule such that the same travel schedule as the selected schedule can be generated, and thus generation of the travel schedule can be made very easily and conveniently.

In addition to this, the reward calculation unit 160 provides a reward for upload of the travel schedule to the second user who has uploaded the travel schedule that is basis for generating the travel schedule of the first user by generating the travel schedule of the first user who copied the uploaded travel schedule, thereby capable of motivating users who use the scheduling system 1 to generate and upload better quality travel schedules.

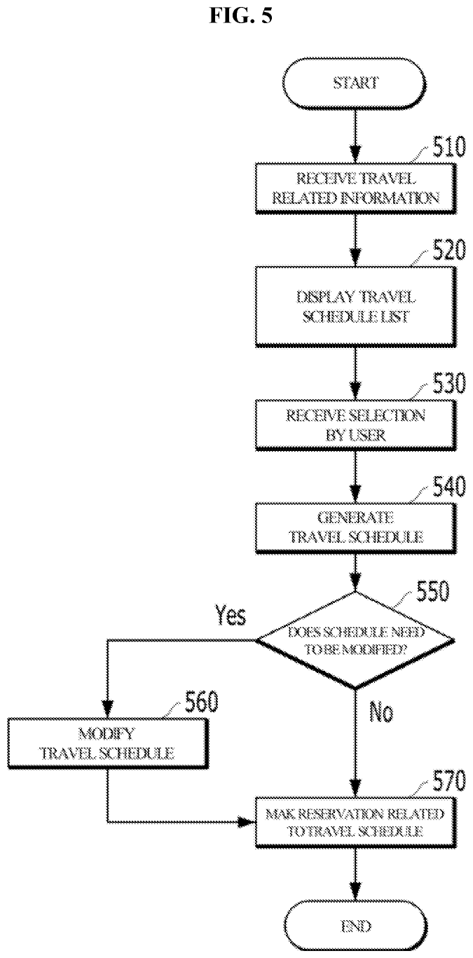

FIG. 5 is a flow chart of a travel scheduling method in accordance with an exemplary embodiment of the present invention. Each step is performed by each component of the scheduling system 1 described above. In order to prevent the description from being redundant and made in duplicate, a detailed method of each step is replaced with a description of the operation of each component of the scheduling system 1 described above.

In step 510, the list generation unit 120 of the scheduling system 1 transmits a travel-related information input screen for receiving travel-related information from the first user to the terminal 3 of the first user, and receives the travel-related information input by the first user in response thereto from the terminal 3 of the first user.

For example, the list generation unit 120 provides the travel-related information input screen including an input field for receiving a desired travel destination, travel period, travel budget, transportation cost budget, and desired concept tag of the first user as travel-related information to the terminal 3 of the first user, and receives the travel-related information of the first user input through the input field of the travel-related information input screen.

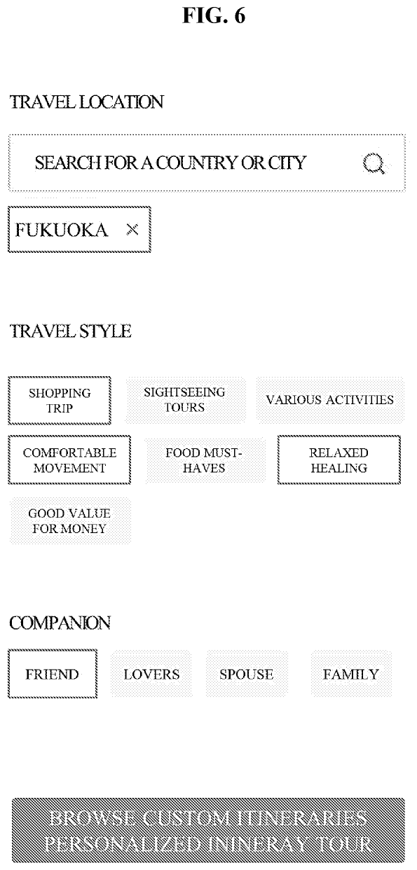

FIG. 6 is a diagram illustrating the travel-related information input screen transmitted by the list generation unit 120 to the terminal 3 of the first user to receive the travel-related information of the first user in accordance with another exemplary embodiment. Referring to FIG. 6, the screen provided to the terminal 3 of the first user by the list generation unit 120 to receive the travel-related information includes an input field for entering a travel destination name (i.e., travel location), travel style (i.e., concept tag), and companion information.

In step 520, the list generation unit 120 of the scheduling system 1 displays a travel schedule list including a plurality of travel schedules on the terminal 3 of the first user. In this embodiment, the list generation unit 120 may generate a travel schedule list to be provided to the first user by selecting one or more travel schedules based on at least one of the travel-related information of the first user received in step 510 among the plurality of travel schedules stored in the database 110 and the preference of the first user automatically calculated by the scheduling system 1.

In this embodiment, the list generation unit 120 of the scheduling system 1 extracts travel schedules generated and uploaded by other users different from the first user when extracting one or more travel schedules from among the plurality of travel schedules, thereby capable of providing a more useful travel schedule list to the first user.

In this embodiment, the preference of the first user may be calculated based on at least one of personal information such as name, gender, contact information, date of birth, etc. of the first user stored in the database 110 by being entered when the first user joined the scheduling system 1 in the past and activity information of the first user in the scheduling system 1 such as a list of travel destinations of interest registered by the first user as travel destinations of interest, a travel schedule generated by the first user using the scheduling system 1, a travel destination search list performed by the first user within the scheduling system 1.

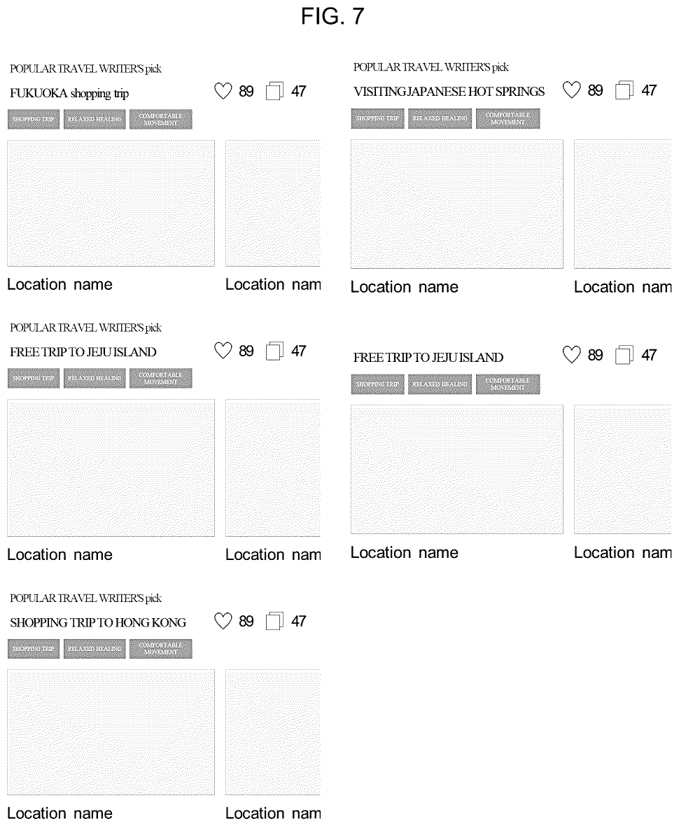

FIG. 7 is a diagram illustrating the travel schedule list displayed on the terminal 3 of the first user by being generated by the list generation unit 120 and transmitted to the terminal 3 of the first user according to an embodiment of the present disclosure. Referring to FIG. 7, it can be seen that a plurality of travel schedules are arranged and displayed on the terminal 3 of the first user so that the first user can select a desired travel schedule. In this time, each travel schedule is listed by displaying only information for distinguishing each travel schedule, e.g., the title, concept set, and photos of each travel schedule.

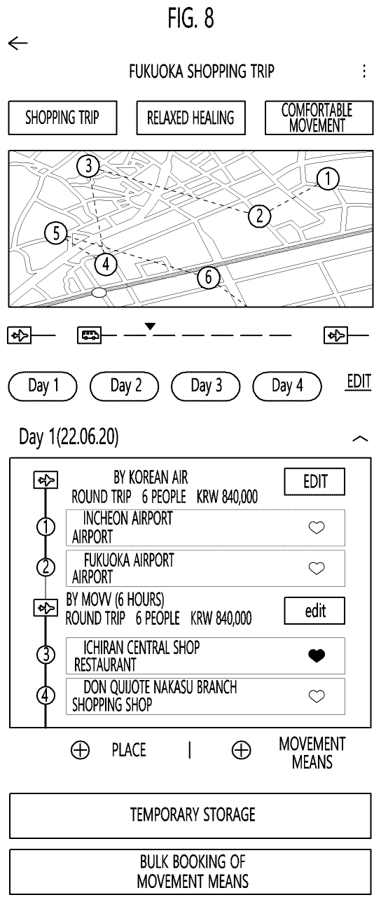

FIG. 8 is an example of a screen displayed on the terminal 3 of the first user when the first user requests detailed information by touching any one of the travel schedules in the list of travel schedules illustrated in FIG. 7. Referring to FIG. 8, the first user can check detailed information about the travel schedule such as travel destinations for each travel day, movement means between respective travel destinations, fares for each movement means, and moving routes between respective travel by touching any one of travel schedules included in the travel schedule list displayed on the terminal 3 of the first user.

In step 530, the schedule generation unit 130 of the scheduling system 1 receives the selection of any one travel schedule that the uses desires to travel from the terminal 3 of the first user in response to display of the travel schedule list on the terminal 3 of the first user in step 510.

In step 540, the schedule generation unit 130 of the scheduling system 1 copies the travel schedule selected by the first user according to the selection by the first user received in step 530 to generate the travel schedule of the first user.

In this embodiment, the schedule generation unit 130 copies the travel period, one or more travel destinations to be visited during the travel period, a usage fee for each travel destination, departure time and arrival time for each travel destination, length of stay at each travel destination, movement means between respective travel destinations and their fare costs, and tag information for each travel schedule from the desired travel schedule selected by the first user and inserts these pieces of information into the user schedule of the first, thereby capable of generating the travel schedule of the first user copied identically to the desired travel schedule selected by the first user.

On the other hand, the schedule generation unit 130 may further include displaying a movement means recommendation screen indicating that the movement means for moving between respective travel destinations in the travel schedule of the first user is to be replaced with the recommended movement means on the terminal 3 of the first user. In this case, the schedule generation unit 130 displays fare cost information of the recommended movement means and a selection button through which the first user can select whether or not to use the recommended movement means on the movement means recommendation screen.

In one embodiment of the present disclosure, the recommended movement means recommended by the schedule generation unit 130 is a vehicle accompanied by a driver, and the vehicle used for this may be a commercial vehicle such as a rental car or a private vehicle owned by the driver. In addition, the fare cost therefor may be calculated by at least one of the moving distance, the size of the provided vehicle, and the moving time.

In another embodiment of the present disclosure, the recommended movement means recommended by the schedule generation unit 130 may be a movement means different from the movement means for moving between respective travel destinations of the desired travel schedule selected by the first user.

On the other hand, in this step, when the movement means recommendation screen is displayed on the terminal 3 of the first user by the schedule generation unit 130 and the first user selects to travel to each travel destination in the travel schedule of the first user using the recommended movement means, steps 550 and 560 may be omitted and processing may proceed to step 570.

In step 550, the schedule adjustment unit 140 of the scheduling system 1 checks the travel schedule of the first user generated by the schedule generation unit 130 in step 540. In this embodiment, the schedule adjustment unit 140 checks the budget appropriateness and the validity of the movement means of the travel schedule of the first user generated in step 540.

The schedule adjustment unit 140 compares the cost for the first user travel schedule generated in step 540 with the budget of the first user received in step 510 to check the budget appropriateness of the travel schedule of the first user, thereby determining whether or not to modify the travel schedule of the first user.

In one embodiment of the present disclosure, the schedule adjustment unit 140 may compare the total cost for the travel schedule of the first user generated in step 540 with the travel budget of the first user received in step 510 to determine the budget appropriateness of the travel schedule of the first user. When the total cost for the first user travel schedule generated in step 540 is greater than the budget of the first user travel received in step 510, the schedule adjustment unit 140 determines that the travel schedule of the first user needs to be modified because the travel schedule of the first user lacks budget appropriateness, and processing proceeds to step 560.

In another embodiment of the present disclosure, the schedule adjustment unit 140 may compare the cost of movement for the travel schedule of the first user generated in step 540 with the transportation cost budget of the first user received in step 510 to determine the budget appropriateness of the travel schedule of the first user. When the cost of movement for the travel schedule of the first user generated in step 540 is greater than the transportation cost budget of the first user received in step 510, the schedule adjustment unit 140 determines that the travel schedule of the first user needs to be modified because the travel schedule of the first user lacks budget appropriateness, and processing proceeds to step 560.

Meanwhile, the schedule adjustment unit 140 determines, based on information of respective movement means stored in the movement means information server 4, whether the movement means between respective travel destinations included in the travel schedule of the first user generated in step 540 is still valid at the time when the first user plans scheduling.

In this embodiment, the schedule adjustment unit 140 receives information about whether or not the corresponding line of each movement means included in the schedule of the first user operates at the current time, whether or not the operation time thereof is changed, and whether or not the fare cost thereof is changed, from the movement means information server 4, and determines, based on the received information, that the movement means is invalid when the line operation of one or more movement means has ended or the operation time or fare has been changed, and processing proceeds to step 560. For example, the schedule adjustment unit 140 determines that the movement using bus No. M is invalid when the bus No. M among the movement means constituting the schedule of the first user is not in operation because the line is currently closed, and determines that the travel schedule of the first user needs to be modified, and processing proceeds to step 560.

In step 560, when it is determined, in step 550, that the travel schedule of the first user needs to be modified, the schedule adjustment unit 140 modifies the travel schedule of the first user. In this embodiment, when it is determined, in step 550, that the travel schedule of the first user needs to be modified because the travel schedule of the first user lacks budget appropriateness or the movement means is not valid, the schedule adjustment unit 140 modifies the travel schedule of the first user by replacing one or more of a plurality of movement means included in the travel schedule.

In this embodiment, when it is determined, in step 550, that the travel schedule of the first user lacks budget appropriateness, the schedule adjustment unit 140 reduces the budget of the travel schedule the first user by replacing at least one movement means among a plurality of movement means constituting the travel schedule of the first user with a cheaper one.

In this embodiment, the schedule adjustment unit 140 checks, through the movement means information server 4, whether or not there is an alternative movement means capable of moving along the same route as each movement means constituting the travel schedule of the first user. More specifically, the schedule adjustment unit 140 checks, through the movement means information server 4, whether or not there is alternative movement means capable of getting on and off at the boarding point and disembarking point of each movement means constituting the travel schedule of the first user. As a result of the check, one or more movement means for which the alternative movement means exists among a plurality of movement means constituting the travel schedule of the first user is set as alternative candidate movement means.

Thereafter, the schedule adjustment unit 140 replaces one or more alternative candidate movement means of the travel schedule of the first user with the alternative movement means based on a cost effect that can be obtained when replacing each alternative candidate movement means with the alternative movement means.

In one embodiment of the present disclosure, the schedule adjustment unit 140 may replace the alternative candidate movement means, for which the cost difference between each alternative candidate movement means and the alternative movement means corresponding to each alternative candidate movement means, that is, the cost saved when each alternative candidate movement means is replaced with each alternative movement means is the greatest, with the alternative movement means.

In another embodiment of the present disclosure, the movement means modification unit 143 may replace the alternative candidate movement means, which has the largest cost savings over time when replaced by the alternative movement means, with the alternative movement means.

Meanwhile, in this embodiment, when it is determined, in step 550, that at least one of the plurality of movement means constituting the travel schedule of the first user is invalid, the schedule adjustment unit 140 replaces the invalid movement means with valid movement means so that the first user can carries out the travel schedule. The schedule adjustment unit 140 checks, through the movement means information server 4, whether or not there is an alternative movement means, which can be used in place of the movement means which is not valid at the time when the first user plans the scheduling, among the movement means constituting the travel schedule of the first user.

More specifically, the schedule adjustment unit 140 checks, through the movement means information server 4, whether or not there is an alternative movement means capable of getting on and off at the boarding point and disembarking point of each invalid movement means constituting the travel schedule of the first user.

As a result of the check, when there is an alternative movement means that can replace the invalid movement means among the plurality of movement means constituting the travel schedule of the first user, a travel schedule in which each invalid movement means is replaced with alternative movement means is generated and provided to the terminal 3 of the first user as the travel schedule of the first user.

In step 570, the reservation unit 150 of the scheduling system 1 displays a reservation screen for making a reservation related to the travel schedule of the first user on the terminal 3 of the first user. In this embodiment, the reservation screen displayed by the reservation unit 150 may include an input field for receiving reservation information of the first user necessary to reserve each means of use, such as the name of the person making the reservation, contact information, passport number, and payment information.

The travel schedule of the first user for whom related reservation is made by the reservation unit 150 in step 570 is the same as the travel schedule generated in step 540 when it is determined that it does not need to be modified in step 550, and is the same as the modified travel schedule in step 560 when it is determined that the travel schedule needs to be modified through step 550.

The reservation unit 150 receives the reservation information of the first user input through the reservation screen from the terminal 3 of the first user, and uses the received reservation information to make reservations for a plurality of movement means included in the travel schedule of the first user.

In one embodiment of the present disclosure, the reservation unit 150 may mediate so that the operating entity of each movement means can make a reservation for the first user, by receiving the reservation information of the first user input through the reservation screen from the terminal 3 of the first user and transmitting the reservation information to the movement means information server 4.

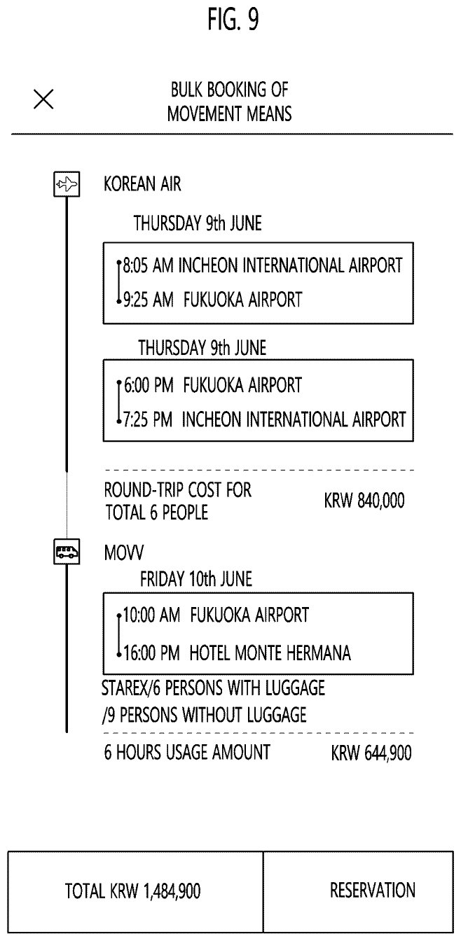

FIG. 9 is a diagram illustrating the reservation screen of the reservation unit 150 according to an embodiment of the present disclosure. Referring to FIG. 9, on the reservation screen displayed on the terminal 3 of the first user by the reservation unit 150, the movement means for moving between respective travel destinations, moving routes and boarding and disembarking times of each movement means, and fare for movements are displayed, and the first user can make reservations for all movement means included in the travel schedule of the first user by pressing a reservation button.

In step 580, when the reservation related to the travel schedule of the first user is completed in step 570, the reward calculation unit 160 of the scheduling system 1 provides a reward to the second user who uploaded the travel schedule which is copied by the first user by being selected by the first user in step 530.

In this embodiment, the reward provided to the second user by the reward calculation unit 160 may be a point or voucher that can be used within the scheduling system 1, but is not limited thereto, and can be easily adopted by those skilled in the art if it can benefit the second user.

In one embodiment of the present disclosure, step 580 may further include calculating a reward to be paid to the second user according to the value of the travel schedule generated by the second user. Accordingly, the reward calculation unit 160 determines an amount of the reward to be provided to the second user based on the value of the travel schedule of the second user copied by the first user.

The reward calculation unit 160 may calculate the value of the travel schedule of the second user based on the ratings stored in the database 110 corresponding to the travel schedule of the second user, and determine the amount of the reward to be provided to the second user according to the calculated value.

For example, the reward calculation unit 160 may provide a reward of approximately 1000 points to the second user when the rating of the travel schedule of the second user copied by the first user is 2 points out of 5 points, and provide a reward of approximately 2000 points to the second user when the rating of the travel schedule of the second user is 4 points. That is, the second user can obtain a higher reward as the travel schedule generated in the past receives a higher rating from other users.

In another embodiment of the present disclosure, the reward calculation unit 160 determines the amount of the reward to be provided to the second user based on the degree of coincidence between the travel schedule of the second user and the travel schedule of the first user generated by copying the travel schedule of the second user.

The reward calculation unit 160 calculates the degree of coincidence between the travel schedule of the second user and the travel schedule of the first user by comparing a plurality of travel destinations and movement means for moving between respective travel destinations that constitute the travel schedule of the second user and the plurality of travel destinations and movement means for moving between respective travel destinations that constitute the travel schedule of the first user, and determines the amount of the reward to be provided to the second user based on the calculated degree of coincidence.

For example, if the schedule of the second user copied by the first user becomes the travel schedule of the first user as it was copied in step 540 without being modified through step 560, the travel schedule of the first user is exactly the same as the travel schedule of the second user, and thus the reward calculation unit 160 may calculate the degree of coincidence between the two travel schedules as 100% and provide a reward of approximately 2000 points to the second user. If the degree of coincidence between the travel schedule of the second user and the travel schedule of the first user is calculated as 50%, the reward calculation unit 160 may provide a reward of approximately 1000 points to the second user. That is, as the travel schedule of the first user and the travel schedule of the second user coincide with each other, the second user can obtain a higher reward.

In this embodiment, in calculating the degree of coincidence between the travel schedule of the first user and the travel schedule of the second user, the reward calculation unit 160 may exclude the first departure point of the first day itinerary and the movement means used at the first departure point of the travel schedule of the first user and the travel schedule of the second user from calculating the degree of coincidence.

So far, the present invention has been described focusing on preferred embodiments. Those skilled in the art to which the present invention pertains will appreciate that the present invention may be implemented in a modified form without departing from the essential characteristics of the present invention. Therefore, the disclosed embodiments should be considered from an illustrative rather than a limiting point of view. The scope of the present invention is shown in the claims rather than the description described above, and all differences within a scope equivalent to the scope of claims shall be construed as being included in the present invention.

In generating a travel schedule by a user, the travel schedule of the user is generated by allowing a travel schedule of another user to be copied by simply selecting the travel schedule generated and uploaded by the other user without entering a travel destination, movement means between respective travel destinations, etc. one by one, thereby capable of generating a travel schedule simply and conveniently.

Although the one-touch travel scheduling system and method thereof have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A travel scheduling method, comprising:
displaying a travel schedule list including a plurality of travel schedules on a terminal of a first user;
receiving a selection of any one travel schedule by the first user from among a plurality of travel schedules from the terminal of the first user;
generating a travel schedule of the first user by copying the travel schedule selected by the first user; and
displaying a reservation screen for making a reservation related to the generated travel schedule of the first user on the terminal of the first user, wherein
the plurality of travel schedules are pre-generated by a plurality of users other than the first user.

2. The method of claim 1, further comprising:
paying a reward to a second user who generated the travel schedule selected by the first user among the plurality of users.

3. The method of claim 2, further comprising:
calculating a reward to be paid to the second user according to a value of the travel schedule generated by the second user, wherein
in the paying the reward, the calculated reward is paid to the second user.

4. The method of claim 3, wherein
in the calculating the reward, the value of the travel schedule generated by the second user is determined based on a score evaluated by at least one other user other than the second user for the travel schedule generated by the second user.

5. The method of claim 4, wherein
each of the at least one other user evaluated for the travel schedule generated by the second user is a user who generated a travel schedule by copying the travel schedule generated by the second user and made a reservation related to the generated travel schedule before generating the travel schedule of the first user.

6. The method of claim 3, wherein
in the calculating the reward, the value of the travel schedule generated by the second user is determined based on a degree of coincidence between the travel schedule generated by the second user and the travel schedule of the first user.

7. The method of claim 6, wherein
in the calculating the reward, the degree of between the travel schedule of the first user and the travel schedule of the second user is calculated, excluding a first departure point of a first day itinerary of the travel schedule of the first user and the travel schedule generated by the second user and a movement means to be boarded at the first departure point.

8. The method of claim 7, further comprising:
receiving information about a travel budget of the first user from the terminal of the first user, and wherein
each travel schedule of the plurality of travel schedules includes information about a budget required for each travel schedule and information about the movement means used to carry out each travel schedule.

9. The method of claim 8, further comprising:
modifying the travel schedule of the first user by replacing at least one of the movement means used to carry out the travel schedule of the first user when the received travel budget of the first user is less than a budget of the travel schedule selected by the first user.

10. The method of claim 9, wherein
the modifying the travel schedule of the first user comprises
determining whether there is an alternative movement means for getting on and off at a boarding point and disembarking point of each movement means of the travel schedule of the first user and having a cheaper fare than that of each movement means, and
determining at least one movement means for which alternative movement means exists as alternative candidate movement means and replacing at least one of the alternative candidate movement means with the alternative movement means.

11. The method of claim 10, wherein
the replacing at least one of the at least one alternative movement means with the alternative movement means comprises
calculating cost savings when each alternate candidate movement means is changed to each alternative movement means, and
replacing the alternative candidate movement means having the largest cost savings with the alternative movement means.

12. The method of claim 10, wherein
the replacing at least one of the at least one candidate movement means with the alternative movement means comprises
calculating cost savings over time by dividing cost savings when each alternate candidate movement means is changed to each alternative movement means by a moving time increment increased by changing each alternative candidate movement means to each alternative movement means, and
replacing the alternative candidate movement means having the largest cost savings over time with the alternative movement means.

13. The method of claim 1, wherein
each travel schedule of the plurality of travel schedules includes information about the movement means used to carry out each travel schedule, and
the travel scheduling method further comprises
displaying, on the terminal of the first user, a movement means recommendation screen indicating that a movement means used to carry out the travel schedule of the first user is to be replaced with a recommended movement means.

14. The method of claim 13, wherein
the recommended movement means is a vehicle accompanied by a driver.

15. A traveling scheduling system, comprising:
a list generation unit configured to display a travel schedule list including a plurality of travel schedules on a terminal of a first user;
a schedule generation unit configured to receive a selection of any one travel schedule by the first user from among a plurality of travel schedules from the terminal of the first user and generate a travel schedule of the first user by copying the travel schedule selected by the first user; and
a reservation unit configured to display a reservation screen for making a reservation related to the generated travel schedule of the first user on the terminal of the first user, wherein
the plurality of travel schedules are pre-generated by a plurality of users other than the first user.
